(19) United States
(12) Patent Application Publication
(10) Pub. No.: US 2007/0026122 A1
(43) Pub. Date: Feb. 1, 2007

(54) Mashed potato

(75) Inventors: Hideki Shimizu, Hiroshima (JP); Hisao Shimizu, Hiroshima (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: SHIMIZU CHEMICAL CORPORATION, Hiroshima (JP)

(21) Appl. No.: 11/493,613

(22) Filed: Jul. 27, 2006

(30) Foreign Application Priority Data
Jul. 28, 2005 (JP) 2005-218985

(51) Int. Cl. A23L 1/05

(52) U.S. Cl. 426/573; 426/637

(57) ABSTRACT

Disclosed is a mashed potato that permits ingestion as much as that adaptable to fully demonstrate functional properties of konjak mannan to be attained, and is rich in water retentiveness, shape maintainability and flavors or tastes etc. The mashed potato according to the present invention is characterized in that addition of konjak mannan containing not less than 50% by weight of konjak mannan components to mashed potato dough is required, and no addition of a coagulant is required. An average particle size of the konjak mannan is not more than 177 μm. A blend of about 100 or more parts by weight of water per one part by weight of konjak mannan is prepared, and the amount of konjak mannan added is in the range of 0.2 to 30% by weight.

### BACKGROUND OF THE INVENTION

1. Field of the Invention

This invention relates to a mashed potato that is available with konjak mannan contained, while requiring no addition of a coagulant.

2. Description of the Prior Art

In general, a mashed potato involves use of potatoes as a material and is in the form of a food prepared by mashing boiled potatoes before having got cooled, and then adding butter, milk and water etc. to quickly form a mixture, before adding seasonings such as salt and pepper. However, the potatoes serving as the material of the mashed potato contain starch, resulting in such disadvantages that the mashed potato undergoes a change (or an aging phenomenon) in quality with time elapsed since cooking and/or causes contained water to ooze through the mashed potato.

Alternatively, as one invention relating to addition of konjak mannan (or glucomannan) to a croquette, the invention described in Japanese Patent No. 3602671 is well known. The above invention is limited to preparation of a mannan croquette, and is intended to overcome stickiness and limp tastes that are mainly caused by the contained water in the croquette.

However, the mannan croquette according to the above invention requires addition of calcium hydroxide serving as a coagulant for a paste made from an arum root as a means of preventing the stickiness, resulting in such disadvantages that the tastes etc. unique to the croquette are spoiled. Thus, addition of the calcium hydroxide serving as the coagulant for the paste made from the arum root as the means of preventing the stickiness has such disadvantages that the tastes etc. unique to the croquette are spoiled.

### SUMMARY OF THE INVENTION

In order to overcome the above disadvantages, a primary object of the present invention is to provide a mashed potato that is applicable to a wide range of food materials with mashed potato flavors or tastes etc. kept, and is also useful as one of functional foods having desired effects on one's health, while ensuring that a change (or an aging phenomenon) with time elapsed since cooking, oozing of the contained water through the mashed potato and stickiness etc. are preventable.

Another object of the present invention is to permit foods having been conventionally required mainly in the form of healthful foods (or tablets and capsules) for ingestion to be ingested in the form of original foods. In other words, the present invention is intended to provide the same effects in relation to an intake of mashed potato per meal as those obtained at the time of ingestion of mashed potato as much as that equal to or greater than that of the health foods by adding a certain amount or more of mashed potato within a range of amounts adaptable to keep flavors and tastes unique to the foods containing the mashed potato.

A further object of the present invention is to permit the mashed potato available for various types of cooking to be applied to a wide range of food items that are easy to be ingested and also provide additional physiological functions.

Although qualities of the mashed potato are liable to be spoiled by a change with the passage of time, the present invention is further intended to add konjak mannan to attain prevention of the mashed potato qualities from being spoiled by the change with the passage of time.

Firstly, a mashed potato of the present invention to solve the above problems is characterized in that addition of konjak mannan containing not less than 50% by weight of konjak mannan components to mashed potato dough is required, and no addition of a coagulant is required.

Secondly, the mashed potato of the present invention is characterized in that an average particle size of the konjak mannan is not more than 177 μm. Use of the konjak mannan having the average particle size of more than 177 μm is undesirable, since uniform mixing with the mashed potato dough fails to be sufficiently attained, leading to creation of tastes unique to the paste made from the arum root.

Thirdly, the mashed potato of the present invention is characterized in that a blend of about 100 or more parts by weight per one part by weight of the konjak mannan is prepared. Use of the blend containing an excessively small amount of water is also undesirable judging from points of uniform mixing with the mashed potato dough and the tastes, like the above.

Fourthly, the mashed potato of the present invention is characterized in that the amount of konjak mannan added is in the range of 0.2 to 30% by weight. Use of the smaller amount of konjak mannan than the above is insufficient to bring out expected effects of the present invention. Conversely, use of the larger amount of konjak mannan than the above has undesirable effects on the flavors and tastes of the mashed potato dough.

### BRIEF DESCRIPTION OF THE DRAWINGS

The above and other objects, features and advantages of the invention will become more apparent from the following description of an embodiment of the present invention with reference to the accompanying drawings, in which:

FIGS. 1A and 1B are photographs showing comparisons in change of shape maintainability and water retentiveness with the passage of time between Example of the present invention and Comparative example (a control).

### DETAILED DESCRIPTION OF THE PREFERRED EMBODIMENT

As a result of examinations in various ways to solve the above problems, the present invention is proved to be effective in increasing water retentiveness obtainable by addition of konjak mannan, in other words, a hydrated amount, and also to be of utility value as one of low-carbohydrate foods. Further, it is also found that the konjak mannan plays an important role in preventing starch from being aged, and provides advantages of causing no change with the passage of time, resulting in no change in tastes at all.

The konjak mannan for use in the present invention is a polysaccharide consisting of D-glucose and D-mannose that are β-1, 4 bonded at a ratio of about 1:1.6, and is generally given by the name of glucomannan, specifically, a storable polysaccharide contained in an arum root, i.e., a tuber thereof so as to share about 8 to 10% therein. In general, a product made through the process of washing the arum root with water, then followed by slicing and drying of the arum root before removal of starches etc. therefrom is referred to as refined konjak flour. However, the embodiment of the present invention requires use of konjak mannan having a purity reaching 85% or more by further giving extraction with alcohol to the above refined konjak flour.

The present invention is to provide the konjak mannan of high safety by improving the purity of the konjak mannan to reach a higher level through extraction with alcohol. While the konjak mannan is different in its quality depending on growing districts, breeds and kinds of arum roots, a refinement technology is supposed to be applicable to adjust these different qualities of the konjak mannan.

Further, it is well known that use of the konjak mannan having a low degree of refinement causes qualities and/or functional properties unique to the konjak mannan to be degraded. A physiological function of the refined konjak mannan has been proved to be effective in relieving constipation, reducing cholesterol concentrations and controlling a blood sugar value and the like. Specifically, it has been observed that the refined konjak mannan is one of concerned components in specific healthful foods to produce an effect on “a reduction in hematic cholesterol concentrations. The intake of the refined konjak mannan in the range of 3 to 7.8 g per day is supposed to take effect.

Further, various physiological functions of the refined konjak mannan other than the above have been also observed by clinical demonstrations and animal experiments. The konjak mannan for use in Example of the present invention includes konjak mannan available by the trade name of “RHEOLEX RS” and “RHEOLEX RX” etc. (manufactured by Shimizu Chemical Corporation).

The present invention is now specifically described with reference to the Example in the following, in which case, however, it is to be understood that the present invention is not limited to the Example.

### EXAMPLE

After adding 4 parts by weight of konjak mannan to 50 parts by weight of mashed potato available on the market to form a mixture, 400 parts by weight of hot water at a temperature of 60 to 70° C. were added to the mixture and then uniformly mixed together. Five minutes after mixing, the mixture was put into a beaker for measurements on viscosity with a B-type viscometer (BH type). The result of measurements on viscosity was about 350,000 mPa·s. Further, 50 g of the above mixture was put into a plastic schale to check to see a change with the passage of time.

### COMPARATIVE EXAMPLE

400 parts by weight of hot water at the temperature of 60 to 70° C. were added to 50 parts by weight of mashed potato available on the market and then uniformly mixed together. Five minutes after mixing, the mixture was put into the beaker for measurements on viscosity with the B-type viscometer (BH type). The result of measurements on viscosity was about 36,000 mPa·s. Further, 50 g of the above mixture was put into the plastic schale to check to see the change with the passage of time.

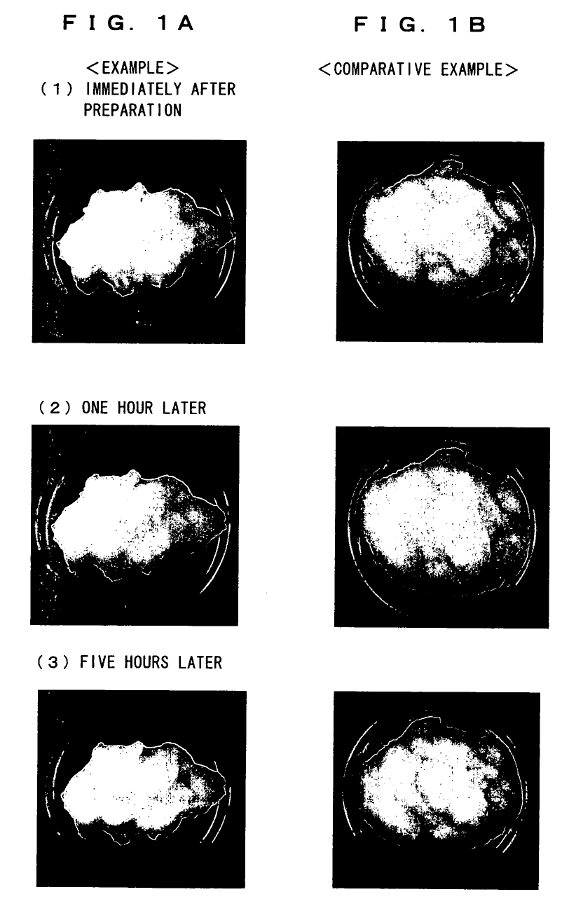

As a result, in relation to the mashed potato of the Example, effects supposed to be produced by addition of the konjak mannan were prominently observed, and there was no great difference in shape maintainability and tastes between the mashed potato of the Example and a conventionally available mashed potato. Conversely, the mashed potato of the Comparative example was used without adding the konjak mannan, so that a water oozing phenomenon occurred after preparation, and no shape maintainability was observed, resulting in the mashed potato different from the conventionally available mashed potato. Referring to photographs in FIGS. 1A and 1B, there is shown the change with the passage of time in relation to the mashed potato of the Example and that of the Comparative example.

As is obvious from FIGS. 1A and 1B, it is found that the mashed potato of the Example keeps up its water retentiveness and shape maintainability even after the passage of one hour and five hours from the period of time immediately after preparation, whereas the mashed potato of the Comparative example gets out of shape and causes the contained water to ooze from the period of time immediately after the preparation.

1. A mashed potato, characterized in that addition of konjak mannan containing not less than 50% by weight of konjak mannan components to mashed potato dough is required, and no addition of a coagulant is required.

2. The mashed potato according to claim 1, wherein an average particle size of the konjak mannan is not more than 177 μm.

3. The mashed potato according to claim 1, wherein a blend of 100 or more parts by weight of water per one part by weight of konjak mannan is prepared.

4. The mashed potato according to claim 1, wherein the amount of konjak mannan added is in the range of 0.2 to 30% by weight.

5. The mashed potato according to claim 2, wherein a blend of 100 or more parts by weight of water per one part by weight of konjak mannan is prepared.

6. The mashed potato according to claim 3, wherein the amount of konjak mannan added is in the range of 0.2 to 30% by weight.
